(19) United States
(12) Patent Application Publication
(10) Pub. No.: US 2019/0033512 A1
(43) Pub. Date: Jan. 31, 2019

(54) OPTICAL DEVICE

(71) Applicant: Fujikura Ltd., Tokyo (JP)

(72) Inventors: Hitoshi Uemura, Sakura-shi (JP); Katsuhiro Takenaga, Sakura-shi (JP)

(73) Assignee: Fujikura Ltd., Tokyo (JP)

(21) Appl. No.: 16/070,886

(22) PCT Filed: Feb. 25, 2016
(86) PCT No.: PCT/JP2016/055602

§ 371 Date: Jul. 18, 2018

(30) Foreign Application Priority Data
Jan. 28, 2016 (JP) 2016-014791

(51) Int. Cl. G02B 6/028; G02B 6/02; G02B 6/036

(52) U.S. Cl. CPC G02B 6/028; G02B 6/03616; G02B 6/03611; G02B 6/02042

(57) ABSTRACT

An optical device includes a plurality of cores and a clad that surrounds outer circumferential surfaces of the cores and has a lower refractive index than the cores. Each of the cores has a large diameter portion, a tapered portion, and a reduced diameter portion formed along a longitudinal direction and has a refractive index gradually increasing from outer circumference to a center. In each of the cores, a radial-direction distance r (μm) from the center, a refractive index n(r) at the distance r, a relative refractive index difference Δ[%] of the center with respect to the clad, a radius r₀ [μm], and a constant α satisfy predetermined formulas and a wavelength λ [nm] of light propagating through the cores and a diameter R of each core before the diameter reduction with respect to a diameter of each core after the diameter reduction satisfy predetermined formulas.

### TECHNICAL FIELD

The present invention relates to an optical device and is suitable for entering/emitting light of a plurality of modes.

### BACKGROUND ART

An optical fiber used in a generally used optical fiber communication system has a structure in which outer circumference of one core is surrounded by a clad and information is transmitted by transmitting an optical signal in the core. Recently, as use of the optical fiber communication system becomes widespread, an amount of information to be transmitted increases dramatically.

To realize an increase in the transmission capacity of the optical fiber communication system, it is known that a multi-core fiber in which outer circumferences of a plurality of cores are surrounded by one clad is used to transmit a plurality of signals by light propagating through each core. To further increase the transmission capacity, transmission using a few-mode multi-core fiber to perform multi-mode communication performing information communication by superimposing information on light of an LP01 mode (basic mode) and superimposing information on light of a higher-order mode than the basic mode such as an LP11 mode in each core of the multi-core fiber is also known.

As an optical device for entering/emitting light with respect to the few-mode multi-core fiber, for example, there is an optical device disclosed in the following Patent Literature 1. The optical device is manufactured by integrating and stretching a single-core optical fiber into each of a plurality of through-holes formed in a capillary and the optical fiber has a tapered portion of which a diameter is reduced from one end side to the other end side. In addition, each optical fiber includes cores and a clad having a lower refractive index than the cores and surrounding the cores. Furthermore, each core includes an inner core having a low refractive index portion and a high refractive index portion having a higher refractive index than the low refractive index portion and surrounding the low refractive index portion and an outer core that has a lower refractive index than the high refractive index portion and surrounds the high refractive index portion.

In the optical device, light propagating from one side of each optical fiber of which the diameter is not reduced to the other side of which the diameter is reduced first propagates through the inner core, spreads from the middle of the tapered portion to the outer core, and propagates through the entire core including the inner core and the outer core. At this time, in a configuration of the refractive index of the core, because the low refractive index portion is surrounded by the high refractive index portion, an intensity distribution of the light of the LP01 mode tends to spread in an outer circumferential direction of the core, as compared with the case where the refractive index of the core is uniform in a radial direction. Therefore, with the diameter reduction of the core, the light of the LP01 mode can be easily shifted from a state where the light propagates through the inner core to a state where the light propagates through the entire core including the inner core and the outer core. In addition, with the diameter reduction of the core, light of other modes can also be shifted from a state where the light propagates through the inner core to a state where the light propagates through the entire core including the inner core and the outer core. In this way, the light of the LP01 mode can be suppressed from staying in the inner core in a state where the diameter of the core is reduced, the light can be suppressed from being emitted in a state where a mode field diameter of the light of each mode is greatly different, and the light can be suppressed from being lost.

### [Patent Literature 1] JP2015-152774 A

### SUMMARY OF INVENTION

To propagate light as intended in the optical device described in the above Patent Literature 1, it is necessary to realize the complex refractive index profile as described above. For example, if an error occurs in a diameter reduction degree of the optical fiber in the course of manufacturing each optical device, an error occurs in sizes of the low refractive index portion, the high refractive index portion, and the outer core at the side where the diameter of the optical fiber is reduced, in the radial direction. That is, an error may occur in a refractive index profile between the optical devices. In addition, an error may occur in a refractive index profile between the optical fibers included in one optical device. If the error occurs in the refractive index profile, for example, a difference may occur in ease spreading of the intensity distribution of the light of the LP01 mode and the like may occur and variations may occur in a light propagation manner. As such, to propagate the light as intended in the optical device described in the above Patent Literature 1, it is necessary to manufacture an optical fiber having a complex refractive index profile by suppressing the error and high manufacturing technology is required.

Accordingly, the present invention provides an optical device that is capable of suppressing variations from occurring in a light propagation manner.

To solve the above problems, an optical device according to the present invention includes a plurality of cores; and a clad that surrounds outer circumferential surfaces of the cores without a gap and has a lower refractive index than the cores. Each of the cores has a tapered portion of which a diameter is reduced from one side to the other side of a longitudinal direction and has a refractive index gradually increasing from outer circumference to a center. When r is set to a radial-direction distance (μm) from the center of the core, n(r) is set to a refractive index of the core at the distance r from the center of the core, Δ is set to a relative refractive index difference [%] of the center of the core with respect to the clad, r₀ is set to a radius [μm] of the core, and a is set to a constant, each core before diameter reduction satisfies the following formulas (1) to (4) and when a wavelength of light propagating through the cores is set to λ [nm] and a diameter of each core before the diameter reduction in the case of setting a diameter of each core after the diameter reduction to 1 is set to R, each core satisfies the following formulas (5) and (6).

n(r)=Δ·{1−(r/r₀)^{-α}} (0≤r≤r₀) (1)

0.9<Δ<1.2 (2)

22.5<r₀<27.5 (3)

1.9<α<2.2 (4)

1530≤λ≤1625 (5)

5581.5/λ<R<9582.4/λ (6)

The present inventors have found that, when the optical device satisfies conditions of the above formulas (1) to (6) and propagates light of a C+L band (1530 nm to 1625 nm), propagation of light of higher-order modes than an LP11 mode is suppressed in the core after the diameter reduction. Therefore, the optical device is suitable for multi-mode communication using light of an LP01 mode and light of the LP11 mode. In addition, the core included in the optical device has a structure of a simple refractive index profile in which the refractive index gradually increases from the outer circumference to the center and does not include a transition from an inner core to an outer core described in the above Patent Literature 1. Therefore, even if a slight difference occurs in a diameter reduction degree of the core, variations are suppressed from occurring in a propagation manner of the light propagating through the core. Hereinafter, the diameter reduction degree may be referred to as a diameter reduction ratio.

Incidentally, when the optical device propagates light of a plurality of modes, inter-mode delay is preferably small. In the optical device, the core is constituted such that the refractive index gradually increases from the outer circumference to the center. By constituting the core as described above, light of a mode traveling in a center portion of the core passes through a portion with a high refractive index and its speed decreases and light of a mode traveling while moving between the center portion and the outer circumferential side of the core passes through an outer circumferential portion with a low refractive index and its speed increases. As a result, a speed difference of each mode is relatively reduced. Therefore, in the optical device, inter-mode delay is suppressed.

To cause each core before the diameter reduction to satisfy the above formulas (1) to (4), optical fibers based on ITU-T G.651 can be used as the core before the diameter reduction and the clad.

The optical device may satisfy the following formula (7).

3.64≤R≤5.90 (7)

Preferably, the optical device includes a capillary that is provided with a plurality of through-holes, the core surrounded by the clad is inserted into each of the through-holes, an outer circumferential surface of the clad is integrated with the capillary, and a refractive index of the capillary is lower than the refractive index of the clad.

The clad is surrounded by the capillary having the lower refractive index than the clad, so that light leaking from the core to the clad is suppressed from leaking from the clad. Therefore, crosstalk is suppressed.

In the optical device, the diameter of the core after the diameter reduction is preferably larger than a diameter of a core of an optical fiber optically connected to the core after the diameter reduction.

The light of the LP01 mode and the light of the LP11 mode mainly propagate through the core after the diameter reduction. However, it is thought that light of higher-order modes also propagates through the core. Because the light of the higher-order modes tends to be unevenly distributed to the outer circumference side of the clad or the core, the diameter of the core of the optical fiber optically connected to the core after the diameter reduction is smaller than the diameter of the core after the diameter reduction, so that it is easy to suppress the light of the higher-order modes from propagating through the core of the optical fiber optically connected to the core after the diameter reduction.

As described above, according to the present invention, an optical device that is capable of suppressing variations from occurring in a light propagation manner is provided.

### BRIEF DESCRIPTION OF DRAWINGS

FIG. 1 is a diagram showing an optical device according to a first embodiment.

FIGS. 2A and 2B are a diagram showing an aspect of a cross-section perpendicular to a longitudinal direction of the optical device in a large diameter portion and a small diameter portion.

FIG. 3 is a diagram showing a relation between a cutoff wavelength and a diameter reduction ratio.

FIG. 4 is a diagram showing an optical device according to a second embodiment.

FIGS. 5A and 5B are a diagram showing an aspect of a cross-section perpendicular to a longitudinal direction of the optical device of FIG. 4.

FIG. 6 is a diagram showing a calculated result of propagation modes to a core after diameter reduction of the optical device according to the first embodiment.

FIG. 7 is a diagram showing a calculation value of a relation between an axial deviation amount and a connection loss in the case where there is a difference in mode field diameters.

FIG. 8 is a diagram showing a calculated result of propagation modes to a core after diameter reduction of an optical device according to a comparative example 1.

### DESCRIPTION OF EMBODIMENTS

Hereinafter, preferred embodiments of an optical device according to the present invention will be described in detail with reference to the drawings.

### First Embodiment

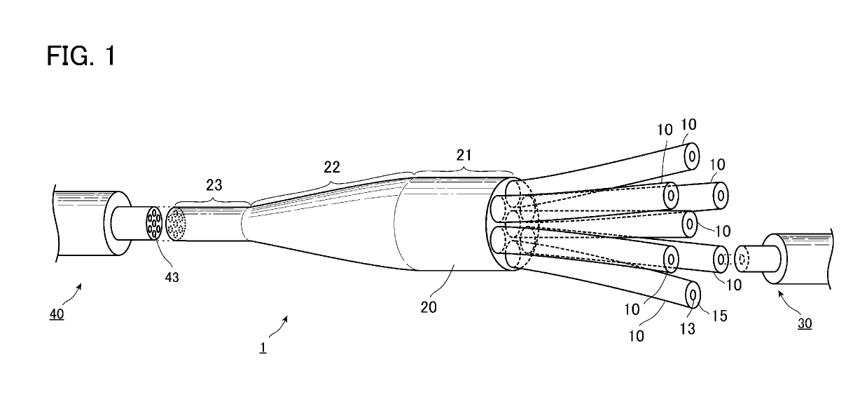

FIG. 1 is a diagram showing an optical device according to a first embodiment of the present invention. As shown in FIG. 1, an optical device 1 according to this embodiment includes a plurality of relay fibers 10 and a capillary 20 as main components. In this example, the number of relay fibers 10 is seven.

The relay fibers 10 are inserted into the capillary 20 from one end to the other end of the capillary 20 and the relay fibers 10 and the capillary 20 are integrated. In addition, portions of the relay fibers 10 that are not inserted into the capillary 20 are exposed.

The capillary 20 has a circular cross-sectional shape and has a large diameter portion 21, a tapered portion 22, and a small diameter portion 23 formed along a longitudinal direction. This shape is formed as follows. First, the capillary provided with the through-holes of the same number as the number of relay fibers to be inserted and having a constant thickness is prepared and the relay fibers are individually inserted into the respective through-holes. Thereafter, the capillary and the relay fibers are integrated by heating and an integral object of the capillary and the relay fibers is melted and drawn. By drawing, the tapered portion 22 and the small diameter portion 23 are formed. Therefore, each relay fiber 10 is also reduced in the diameter according to diameter reduction of the capillary 20 in the tapered portion 22 of the capillary 20 and each relay fiber 10 also has a small diameter in the diameter in the small diameter portion 23.

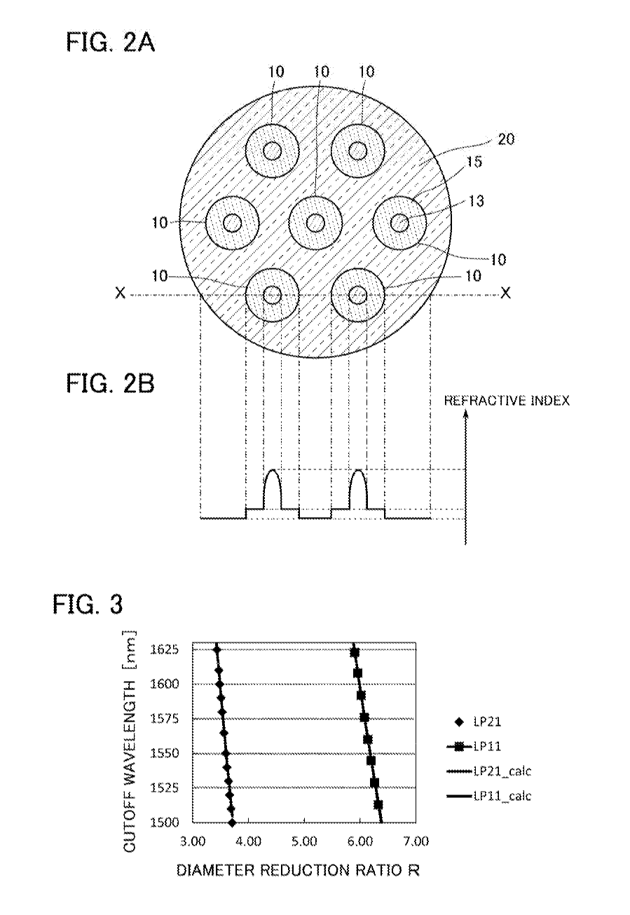

FIGS. 2A and 2B are a diagram showing an aspect of a cross-section perpendicular to a longitudinal direction at a position including the capillary 20 of the optical device 1. Specifically, FIG. 2A shows an aspect of a structure in the cross-section and FIG. 2B shows an aspect of a refractive index profile along the line X-X of the cross-section. In the case of this example, a ratio of an outer diameter of each relay fiber 10 to an outer diameter of the capillary 20 is the same in all of the large diameter portion 21, the tapered portion 22, and the small diameter portion 23, in the case of the cross-section perpendicular to the longitudinal direction of the capillary. Therefore, it is not necessary to specify a position of the capillary 20 from which a cross-sectional view is taken.

As described above, the number of relay fibers 10 according to this embodiment is seven, one relay fiber 10 is disposed on a center of the capillary 20, and the six relay fibers 10 are disposed around the relay fiber 10 disposed on the center. In this state, lines connecting the centers of the respective relay fibers 10 form a triangular lattice and inter-center pitches of the relay fibers 10 adjacent to each other are the same.

As illustrated in FIGS. 1 and 2A, each relay fiber 10 is a single-core optical fiber that has a core 13 and a clad 15 surrounding an outer circumferential surface of the core 13 without a gap. As described above, the ratio of the diameter of each relay fiber 10 to the outer diameter of the capillary 20 does not change in all of the large diameter portion 21, the tapered portion 22, and the small diameter portion 23. Therefore, the diameter of each relay fiber 10 is reduced in the tapered portion 22 from the side of the large diameter portion 21 to the side of the small diameter portion 23. For this reason, diameters of the core 13 and the clad 15 of the relay fiber 10 are reduced from the side of the large diameter portion 21 to the side of the small diameter portion 23, in a state where ratios of the respective diameters are maintained.

In addition, as shown in FIG. 2B, a refractive index of the core 13 gradually increases from the outer circumference to the center, the refractive index of the core 13 is higher than the refractive index of the clad 15, and the refractive index of the clad 15 is higher than the refractive index of the capillary 20.

Specifically, the refractive indexes of each core 13 and each clad 15 satisfy conditions of the following formulas (1) to (4) in a state before diameter reduction.

n(r)=Δ·{1−(r/r₀)^{-α}} (0≤r≤r₀) (1)

0.9<Δ<1.2 (2)

22.5<r₀<27.5 (3)

1.9<α<2.2 (4)

Here, r is a radial-direction distance (μm) from the center of the core 13, n(r) is a refractive index of the core 13 at the distance r from the center of the core 13, A is a relative refractive index difference [%] of the center of the core 13 with respect to the clad 15, r₀ is a radius [μm] of the core 13, and a is a constant.

As the optical fiber having the core 13 and the clad 15 satisfying the formulas (1) to (4), a multi-mode optical fiber based on ITU-T G.651 is exemplified.

When a wavelength λ [nm] of the light propagating through the core 13 satisfies a condition of the following formula (5), to propagate light of an LP01 mode and light of an LP11 mode, but suppress propagation of light of higher-order modes than the LP11 mode in the core 13 after the diameter reduction, a condition of the following formula (6) may be satisfied.

1530≤λ≤1625 (5)

5581.5/λ<R<9582.4/λ (6)

Here, R is a diameter of the core 13 before the diameter reduction when the diameter of the core 13 after the diameter reduction is set to 1. That is, R is a diameter reduction ratio.

The above formula (6) is obtained as follows. Here, a relation between a cutoff wavelength of the LP11 mode and a cutoff wavelength of the LP21 mode with respect to the diameter reduction ratio R by a simulation using the optical fiber based on ITU-T G.651 is shown in FIG. 3. In FIG. 3, ♦ shows the cutoff wavelength of the LP21 mode and ▪ shows the cutoff wavelength of the LP11 mode. In addition, if a simulation result of the cutoff wavelength of the LP21 mode is represented by an approximation formula, the following formula (8) is obtained and when a simulation result of the cutoff wavelength of the LP11 mode is represented by an approximation formula, the following formula (9) is obtained.

LP_{21-calc}=5581.5/R (8)

LP_{11-calc}=9582.4/R (9)

Therefore, it is seen that the following formula (10) may be satisfied to constitute the core 13 such that the light of the LP01 mode and the light of the LP11 mode can propagate through the core 13, while propagation of the light of the higher-order modes than the LP11 mode is suppressed.

LP_{21-calc}(R)<λ<LP_{11-calc}(R) (10)

In addition, the above formula (6) is obtained by the above formulas (8) to (10).

Further, it is seen that the diameter reduction ratio R may satisfy at least the following formula (7) from the above formula (6), when the wavelength λ is in a range of the above formula (5).

3.64≤R≤5.90 (7)

In the optical device 1, as shown in FIG. 1, a single-core few-mode fiber 30 is optically connected to each core 13 at an end portion of the side of the large diameter portion 21. In addition, in the optical device 1, an end portion of the side of the small diameter portion 23 is connected to a few-mode multi-core fiber 40 including a core 43 optically connected to each core 13. The diameter of the core 13 after the diameter reduction is larger than the diameter of the core 43.

The light propagates through each core 13 of the optical device 1 as follows. First, at the end portion of the side of the large diameter portion 21, the light propagates from the few-mode fiber 30 to the core 13. The light propagating through the few-mode fiber 30 is mainly the light of the LP01 mode and the light of the LP11 mode and the light propagating from the few-mode fiber 30 to the core 13 is mainly the light of the LP01 mode and the light of the LP11 mode. However, because the diameter of the core 13 before the diameter reduction is sufficiently large, light of several hundred modes can propagate through the core 13. Therefore, it is thought that the light of the higher-order modes than the LP11 mode also propagates through the core 13. However, the core 13 and the clad 15 satisfy the conditions described above, propagation of the light of the higher-order modes than the LP11 mode is suppressed in the core 13 after the diameter reduction, and the light of the higher-order modes is lost. In addition, at the end portion of the side of the small diameter portion 23, the light of the LP01 mode and the light of the LP11 mode mainly propagate from each core 13 to each core 43 of the few-mode multi-core fiber 40. Here, because the light of the higher-order modes tends to be unevenly distributed to the outer circumference side of the clad 15 or the core 13, the diameter of the core 13 after the diameter reduction is larger than the diameter of the core 43 of the few-mode multi-core fiber 40, so that it is easy to suppress the light of the higher-order modes than the LP11 mode from propagating through the core 43.

As described above, according to the optical device 1 according to this embodiment, when light of a C+L band (1530 nm to 1625 nm) is propagated by satisfying the conditions of the above formulas (1) to (6), propagation of the light of the higher-order modes than the LP11 mode is suppressed in the core 13 after the diameter reduction. Therefore, the optical device 1 is suitable for multi-mode communication using the light of the LP01 mode and the light of the LP11 mode. The core 13 included in the optical device 1 has a structure of a simple refractive index profile in which the refractive index gradually increases from the outer circumference to the center and does not include a transition from an inner core to an outer core described in the above Patent Literature 1. Therefore, even if a slight difference occurs in the diameter reduction ratio of the core 13, variations are suppressed from occurring in a propagation manner of the light propagating through the core 13.

In addition, in the optical device 1, the core 13 is constituted such that the refractive index gradually increases from the outer circumference to the center. As a result, the light of the mode traveling in the center portion of the core 13 passes through the portion with the high refractive index and its speed decreases and the light of the mode traveling while moving between the center portion and the outer circumferential side of the core 13 passes through the outer circumferential portion with the low refractive index and its speed increases. As a result, a speed difference of light of each mode is relatively reduced. Therefore, in the optical device 1, inter-mode delay is suppressed.

In addition, in the optical device 1, the clad 15 is surrounded by the capillary 20 having the lower refractive index than the clad 15, so that light leaking from the core 13 to the clad 15 is suppressed from leaking from the clad 15. Therefore, crosstalk is suppressed.

### Second Embodiment

Next, a second embodiment of the present invention will be described. Components that are the same as or equivalent to those of the first embodiment will be denoted by the same reference numerals and redundant explanation will be omitted, except for when particularly described.

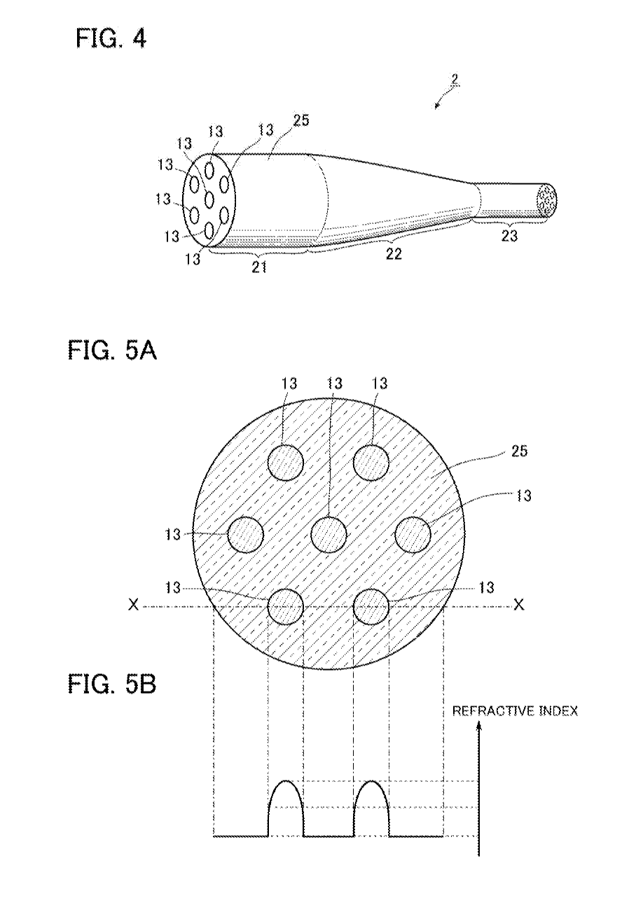

FIG. 4 is a diagram showing an optical device according to the second embodiment of the present invention, FIG. 5A is a diagram showing an aspect of a cross-section perpendicular to a longitudinal direction of an optical device 2 shown in FIG. 4, and FIG. 5B is a diagram showing an aspect of a refractive index profile along the line X-X in the cross-section. As shown in FIGS. 4, 5A and 5B, the optical device 2 according to this embodiment is different from the optical device according to the first embodiment in that outer circumferential surfaces of cores 13 are surrounded by a clad 25 made of the same glass as glass constituting clads 15 according to the first embodiment, without a gap, and the cores 13 are located only in the clad 25. That is, the optical device 2 according to this embodiment is obtained by removing portions of relay fibers 10 exposed from a capillary 20 and constituting each clad 15 and the capillary 20 using the clad 25 made of the same glass as the glass constituting the clad 15, in the optical device 1 according to the first embodiment.

For example, the optical device 2 is manufactured by manufacturing a multi-core fiber having a cross-section of a structure shown in FIG. 5A and having the same thickness as the thickness of a large diameter portion 21, melting and drawing the multi-core fiber, and forming a tapered portion 22 and a small diameter portion 23.

The optical device 2 according to this embodiment satisfies the conditions of the above formulas (1) to (6), similar to the optical device 1 according to the first embodiment.

Even in the case of the optical device 2 using the multi-core fiber, light of multi-modes can be propagated in the same way as the optical device 1 according to the first embodiment.

Although the present invention has been described using the above embodiments as examples, the present invention is not limited thereto.

For example, the number of relay fibers 10 in the first embodiment or the number of cores 13 in the second embodiment can be appropriately changed.

In the first embodiment, the refractive index of the capillary 20 is lower than the refractive index of the clad 15. However, the refractive index of the capillary 20 and the refractive index of the clad 15 may be equal to each other.

In addition, in the first embodiment, the diameter of the core 13 after the diameter reduction is larger than the diameter of the core 43 of the few-mode multi-core fiber 40 optically connected to the core 13 after the diameter reduction. However, the diameter of the core 13 may be the same as the diameter of the core 43 or may be smaller than the diameter of the core 43.

### EXAMPLE

Hereinafter, the present invention will be described more specifically using examples and comparative examples. However, the present invention is not limited to the following examples.

### Example 1

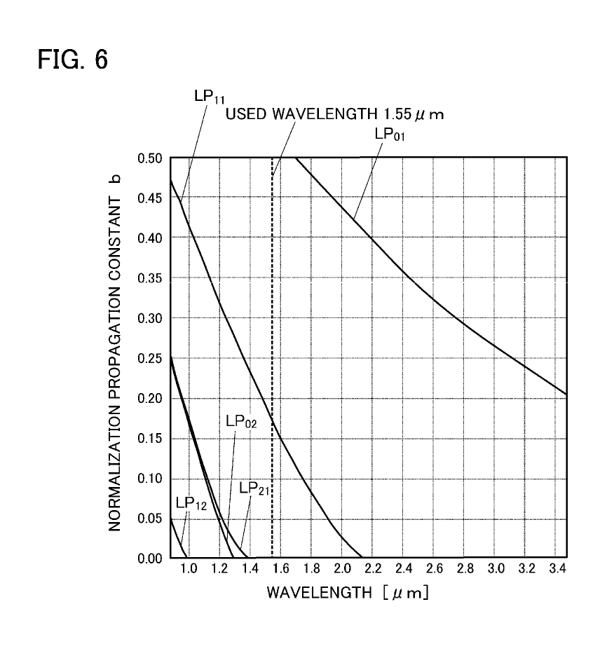

The optical device 1 according to the embodiment is manufactured as follows. First, seven Future Guide-MM50 multi-mode fibers (they are manufactured by Fujikura and Future Guide is a registered trademark) based on ITU-T G.651 are prepared as optical fibers to be the relay fibers 10 and a capillary provided with seven through-holes is prepared. A relative refractive index difference of the glass constituting the capillary with respect to the clad of the optical fiber is −0.35%. In addition, an inter-center pitch of the through-holes formed in the capillary is 153 μm and a diameter of the through-hole is 135 μm. The optical fibers are inserted into the through-holes of the capillary and heated to integrate the clads and the capillary and an integral object is drawn such that a core pitch after diameter reduction is 30 μm (diameter reduction ratio of 4.77). A calculated result of propagation modes to the core after the diameter reduction in the optical device manufactured in this way is shown in FIG. 6.

As seen from FIG. 6, when light having a wavelength of 1.55 μm is propagated, light of an LP01 mode and light of an LP11 mode are propagated and light of higher-order modes than these modes is not propagated, in the optical device according to the example 1. In the example 1, the used optical fiber satisfies the conditions of the above formulas (1) to (4) and the diameter reduction ratio satisfies the condition of the above formula (6).

In addition, the light of the LP01 mode and the light of the LP11 mode are entered from the diameter non-reduction side of the optical device manufactured under the above conditions and a near field pattern (NFP) at the other end is observed. As a result, it is confirmed that propagation of extra light of the higher-order modes is suppressed and the light of the LP01 mode and the light of the LP11 mode are propagated, in all cores. In addition, it is confirmed that an effective area and a mode field diameter (MFD) of the light of the LP01 mode in the core after the diameter reduction are 38 μm² and 7.0 μm in calculated values, respectively, but almost the calculated MFD is obtained from a distribution of the light of the LP01 mode. At this time, an insertion loss in the core disposed on the center is 0.33 dB in the light of the LP01 mode and 0.98 dB in the light of the LP11 mode. Here, the insertion loss is defined as a ratio of power of the entered light of each mode to total light power at an emission end.

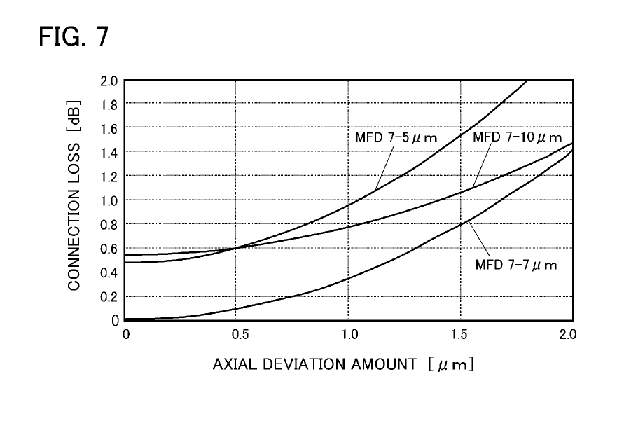

In addition, a calculation value of a relation between an axial deviation amount and a connection loss in the case where there is a difference in the MFD is shown in FIG. 7. In FIG. 7, “MFD 7-5 μm” shows the case where a few-mode multi-core fiber having a core in which the MFD of the LP01 mode is 5 μm is connected to the diameter reduction side of the optical device according to the example 1. In addition, “MFD 7-7 μm” shows the case where a few-mode multi-core fiber having a core in which the MFD of the LP01 mode is 7 μm is connected to the diameter reduction side of the optical device and “MFD 7-10 μm” shows the case where a few-mode multi-core fiber having a core in which the MFD of the LP01 mode is 10 μm is connected to the diameter reduction side of the optical device From a graph of FIG. 7, it is seen that, if it is assumed that an axial deviation amount between the core of the optical device according to the example 1 and the core of the few-mode multi-core fiber connected to the optical device can be suppressed to 0.5 μm or less, a loss due to the axial deviation is a maximum of about 0.6 dB when the MFD of the core of the fiber of the connection destination is in a range of 5 μm to 10 μm (20 μm² to 80 μm² in terms of the effective area). Therefore, according to the optical device according to the example 1, it is seen that a total loss of the light of the LP01 mode including the loss due to the axial deviation and the insertion loss described above is suppressed to 1 dB or less.

### Comparative Example 1

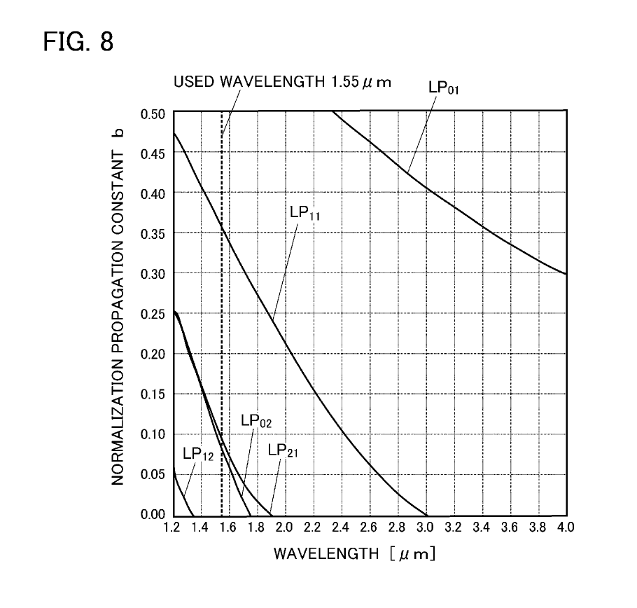

An optical device is manufactured in the same way as the example 1, except that drawing is performed such that a core pitch after the drawing is 40 μm (diameter reduction ratio of 3.58). A calculated result of propagation modes to a core after diameter reduction in the optical device manufactured in this way is shown in FIG. 8.

As seen from FIG. 8, when light having a wavelength of 1.55 μm is propagated, light of an LP02 mode and light of an LP21 mode as well as light of an LP01 mode and light of an LP11 mode are propagated in the optical device according to the comparative example 1. In addition, the diameter reduction ratio according to the comparative example 1 does not satisfy the condition of the above formula (6).

In the optical device according to the present invention, variations are suppressed from occurring in a light propagation manner. Therefore, the optical device can be used in industries handling multi-core fibers.

### REFERENCE SIGNS LIST

1, 2 . . . optical device
10 . . . relay fiber
13 . . . core
15 . . . clad
20 . . . capillary
21 . . . large diameter portion
22 . . . tapered portion
23 . . . small diameter portion
25 . . . clad

1. An optical device comprising:
a plurality of cores; and a clad that surrounds outer circumferential surfaces of the cores and has a lower refractive index than the cores, wherein
each of the cores has a tapered portion of which a diameter is reduced from one side to the other side of a longitudinal direction and has a refractive index gradually increasing from outer circumference to a center,
when r is set to a radial-direction distance (μm) from the center of the core, n(r) is set to a refractive index of the core at the distance r from the center of the core, Δ is set to a relative refractive index difference [%] of the center of the core with respect to the clad, r₀ is set to a radius [μm] of the core, and a is set to a constant, each core before diameter reduction satisfies the following formulas (1) to (4), and
when a wavelength of light propagating through the cores is set to λ [nm] and a diameter of each core before the diameter reduction in the case of setting a diameter of each core after the diameter reduction to 1 is set to R, each core satisfies the following formulas (5) and (6):
n(r)=Δ·{1−(r/r₀)^{-α}} (0≤r≤r₀) (1)
0.9<Δ<1.2 (2)
22.5<r₀<27.5 (3)
1.9<α<2.2 (4)
1530≤λ≤1625 (5)
5581.5/λ<R<9582.4/λ (6).

2. The optical device according to claim 1, wherein the core before the diameter reduction and the clad include optical fibers based on ITU-T G.651.

3. The optical device according to claim 1, wherein the following formula (7) is satisfied:
3.64≤R≤5.90 (7).

4. The optical device according to claim 1, further comprising:
a capillary that is provided with a plurality of through-holes, wherein
the core surrounded by the clad is inserted into each of the through-holes and an outer circumferential surface of the clad is integrated with the capillary, and
a refractive index of the capillary is lower than the refractive index of the clad.

5. The optical device according to claim 1, wherein the diameter of the core after the diameter reduction is larger than a diameter of a core of an optical fiber optically connected to the core after the diameter reduction.
